(19) United States
(12) Patent Application Publication
(10) Pub. No.: US 2006/0025896 A1
(43) Pub. Date: Feb. 2, 2006

(54) Coordination of a vehicle dynamics control system with a rear-wheel steering system

(76) Inventors: Ansgar Traechtler, Borchen (DE); Thomas Ehret, Abstatt (DE); Manfred Gerdes, Vaihingen/Enz (DE); Volker Mehl, Weingarten (DE); K. Hsiencheng Wu, Novi, MI (US); Daniel Patient, Novi, MI (US)

Correspondence Address: KENYON & KENYON, ONE BROADWAY, NEW YORK, NY, 10004, US

(21) Appl. No.: 11/193,800

(22) Filed: Jul. 28, 2005

(30) Foreign Application Priority Data
Jul. 28, 2004 (DE) 10 2004 036 565.2

(51) Int. Cl. G06F 19/00

(52) U.S. Cl. 701/1; 701/41; 701/70

(57) ABSTRACT

A device is described for stabilizing a vehicle in critical driving situations, including a vehicle dynamics control system having a control unit, in which a vehicle dynamics controller is stored, at least one final control element, and a sensor system for measuring different driving condition variables, and including a rear-wheel steering system having a control unit and a final control element. The electronic stability program may be integrated into a control unit if the electronic stability program algorithm includes a distributor unit which, from a regulator output variable, generates both a setpoint requirement for the final control element of the vehicle dynamics control system and also a setpoint requirement for the final control element of the rear-wheel steering system.

### FIELD OF THE INVENTION

The present invention relates to a vehicle dynamics control system, and a method for stabilizing a vehicle in critical driving situations according to the present invention.

### BACKGROUND INFORMATION

Vehicle dynamics control systems, such as ESP (electronic stability programs), are used for the purpose of improving the controllability of motor vehicles in critical driving situations, for example, upon oversteering when negotiating curves, and stabilizing the vehicle. Known vehicle dynamics control systems include a control unit, in which a control algorithm for executing a float angle and/or yaw rate regulation is stored, as well as an array of sensors which provide measured values about the current driving condition of the vehicle. Different setpoint variables are calculated from the driver selection, in particular the steering wheel position, the accelerator pedal position, and the brake operation. In the event of too high a deviation of the actual behavior from the setpoint behavior of the vehicle, the electronic stability program intervenes in the vehicle operation and produces a compensating yaw moment, which counteracts the yaw movement of the vehicle. For this purpose, the vehicle dynamics control system typically operates the vehicle brakes and/or the engine controller as final controlling elements.

Modern vehicles also increasingly include active rear-wheel steering systems, which may also intervene in the vehicle operation for the purpose of vehicle stabilization. Systems of this type typically include a separate control unit and a steering control element, using which the steering angle of the rear wheels may be adjusted. The control algorithm of the rear-wheel steering system typically also determines different setpoint values of driving condition variables, such as a setpoint yaw rate or a setpoint float angle, and calculates a required stabilization intervention (the superimposed steering angle) from the system deviation. The calculated steering angle changes are implemented using a steering control element and influence the driving behavior of the vehicle.

Since both the electronic stability program ESP and the active rear-wheel steering system (RWS) perform stabilization interventions, this may result in the two systems mutually impairing one another and, in the worst case, the driving safety being endangered.

### SUMMARY OF THE INVENTION

It is therefore an object of the present invention to coordinate the stabilization interventions of the vehicle dynamics control system and the rear-wheel steering system.

An aspect of the present invention is providing an expanded vehicle dynamics control system (VDM), which may also address a steering control element of the rear-wheel steering system, in addition to the brake system and the engine controller, and providing this VDM system with only one single control algorithm, which generates a controller output variable (e.g., a yaw moment), from which both an actuation request for a final control element (i.e., the brake system or the engine controller) of the vehicle dynamics control system and also for the steering control element of the rear-wheel steering system are generated. This type of central regulation may be implemented particularly easily and is safe and reliable.

The corresponding control algorithm may be implemented, for example, in the control unit of the vehicle dynamics control system. The currently existing electronic stability program algorithm (ESP) must only be slightly supplemented and adapted for this purpose. Preferably, no separate electronic stability program is executed in the control unit of the rear-wheel steering system.

The expanded vehicle dynamics controller (VDM) preferably includes a distributor unit, which generates both an actuation for the brake system and the engine controller and an actuation for the steering control element of the rear-wheel steering system from the controller output variable.

The control unit of the expanded vehicle dynamics control system (VDM) and the control unit of the rear-wheel steering system (RWS) are preferably connected to a shared data bus (e.g., a chassis CAN), via which different types of steering angle information are transmitted. In addition, the VDM control unit is preferably connected to a further bus (e.g., a PT CAN), via which different types of sensor information of the VDM sensor system are transmitted in particular. Through the separate transmission of steering angle and other sensor information, the data transmission speed may be elevated and system security may be improved.

In an expanded electronic stability program (VDM), as was described above, some special control technology characteristics arise, which will be explained in greater detail in the following:

1. Adaptation of the Control Behavior of the Yaw Rate and Float Angle Regulators

Known vehicle dynamics controllers typically include a yaw rate regulator and a float angle regulator, which generate a regulator output variable as a function of their associated system deviation, from which the manipulated variable for the brake system (hydraulic modulator) and/or the engine controller (motronics) is calculated. The expanded vehicle dynamics control system (VDM) according to the present invention also calculates a manipulated variable for the rear-wheel steering system as a function of the system deviation. The following set of problems thus results in regard to the yaw rate and float angle regulation:

Basically, a control intervention of the yaw rate regulator in the rear-wheel steering simultaneously also has an influence on the float angle of the vehicle. In contrast to a braking intervention, the intervention in the rear-wheel steering causes an increase in the float angle while reducing the yaw rate. A control intervention of the float angle regulator in the rear-wheel steering, in contrast, causes an increase in the yaw rate while reducing the float angle. The interventions of the two regulators thus act in precisely opposite directions.

In both cases, the operating point of one regulator is shifted as a function of the actuator intervention of the other regulator. The two regulators may thus mutually amplify one another and impair the stability of the vehicle. It is therefore suggested that the regulation behavior of the yaw rate regulator preferably be adapted as a function of the share of the slip angle regulator in the manipulated variable for the rear-wheel steering system and the regulation behavior of the slip angle regulator be adapted as a function of the share of the yaw rate regulator. For this purpose, for example, the sensitivity of the regulators may be varied correspondingly.

To influence the regulator sensitivity, either the control threshold of the regulator may be adapted or the system deviation itself may be corrected. Thus, for example, the system deviation of the yaw rate regulator may be set as a function of the share of the float angle regulator in the manipulated variable for the rear-wheel steering system and the system deviation of the float angle regulator may be set as a function of the share of the yaw rate regulator.

A correction unit is preferably provided for adapting the system deviation, which generates a corrected system deviation from the system deviations of each of the regulators, which then forms the basis for the yaw rate and/or float angle regulation. The correction unit preferably defines a dead zone, i.e., a range of the system deviation in which the system deviation is set to zero, and a range in which the original system deviation is reduced by a predefined absolute value. The operating point displacements of one regulator because of the control interventions of the particular other regulator are thus compensated for.

2. Activation/Deactivation of the Yaw Rate Regulator in Specific Ranges as a Function of the Slip Angle

In the event of high slip angles of the rear axle wheels, only a very weak effect or even no effect may be exerted on the driving behavior of the vehicle through the change of the rear-wheel steering angle, since the tire transverse forces change only slightly at large slip angles. In the range of larger slip angles (e.g., between 3° and 5°), in particular at a low coefficient of friction (e.g., on snow), hardly any further steering effect may be achieved by turning the steering wheel further. In order to nonetheless be able to stabilize the vehicle, it is therefore suggested that in a range of larger slip angles (which may differ depending on the road surface substrate), the electronic stability program be allowed to intervene more strongly in the vehicle operation via the brake system and/or the engine controller than in a range of smaller slip angles.

According to a preferred embodiment of the present invention, the yaw rate regulator or float angle regulator is thus activated in a predefined slip angle range (in particular at large slip angles) and deactivated in another range (in particular at small slip angles), or at least its effect is reduced. According to the present invention, in particular, stabilizing interventions in the rear-wheel steering are not suppressed, since in this case the steering behavior of the vehicle would change. This would no longer be controllable by the driver or would at least place great demands on the driver. The stability interventions in the rear-wheel steering are therefore preferably not interrupted in the range of higher slip angles.

For the purpose of activating/deactivating braking interventions, for example, a clearing signal (CRS) may be generated, using which stability interventions in the brake system are permitted and/or suppressed. The clearing signal is preferably a function of the slip angle having maximum adhesion at a predefined road surface coefficient of friction. (The road surface coefficient of friction is typically estimated by the control algorithm.) The slip angles having maximum adhesion at different coefficients of friction are preferably mathematically approximated using a characteristic curve.

3. Calculating the Superimposed Steering Angle from the Regulator Output Variable

The expanded vehicle dynamics control system (VDM) preferably includes a computer unit, using which the corresponding manipulated variable (superimposed steering angle) is calculated from the component of the moment relative to the center of gravity which is to be implemented by the rear-wheel steering. In order to ensure that this manipulated variable does not assume too high or incorrect values in any case, thus endangering the driving safety, one or more of the following processing steps may be executed:

The raw value of the superimposed steering angle obtained from the conversion of torque into superimposed steering angle is preferably scaled and limited as a function of the estimated coefficient of friction. For this purpose, a device is preferably provided which defines a dead zone, i.e., sets the superimposed steering angle to zero for small steering angle changes and reduces the superimposed steering angle by a predefined value in the remaining range.

The size of the dead zone is preferably also a function of the (estimated) road surface coefficient of friction.

Through the cited measures, the robustness of the electronic stability program and the steerability of the vehicle may be improved in particular.

4. Special Embodiment of the Yaw Rate Regulator

The yaw rate regulator of the expanded VDM system is preferably implemented as a PID regulator. The stabilization behavior may thus be significantly improved in relation to a typical P regulator.

The regulating behavior of the I and D components of the yaw rate regulator also brings a certain set of problems with it, which are based in particular on the fact that the output signal of the I component must be set back to zero as rapidly as possible after an adjustment and the D component is relatively noise-sensitive. In order to prevent too strong a stabilization intervention by the I and D components of the PID regulator, the influence of the I and D regulator is preferably reduced as a function of the coefficient of friction. Disproportionately strong control interventions may thus be avoided in the event of road surfaces having low coefficients of friction in particular.

In addition, a device is preferably provided which permits relatively high manipulated variables of the I and D regulator at the beginning of a stability regulation and reduces the components of the I and D regulator as a function of the coefficient of friction after a first steering intervention. This has the advantage that, in particular during steady-state straight travel, during which the coefficient of friction of the road surface may be estimated relatively poorly by the regulator, a relatively high regulator amplification of the I and D components is first permitted at the beginning of the stability regulation and the regulator amplification is stabilized at lower regulator amplifications as a function of the coefficient of friction in the course of the stability regulation.

According to a preferred embodiment of the present invention, the regulating behavior of the PID regulator is therefore designed as a function of the coefficient of friction. In addition to the regulator amplification, other regulator parameters may also be a function of the coefficient of friction.

### SUMMARY OF THE INVENTION

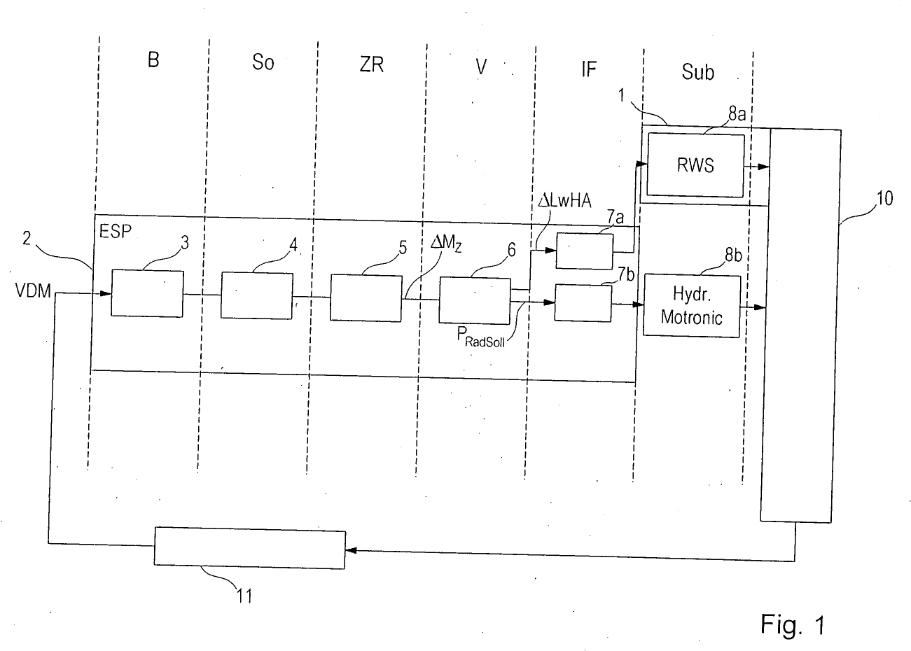

FIG. 1 shows a schematic block diagram of an expanded vehicle dynamics control system VDM having an active rear-wheel steering system RWS.

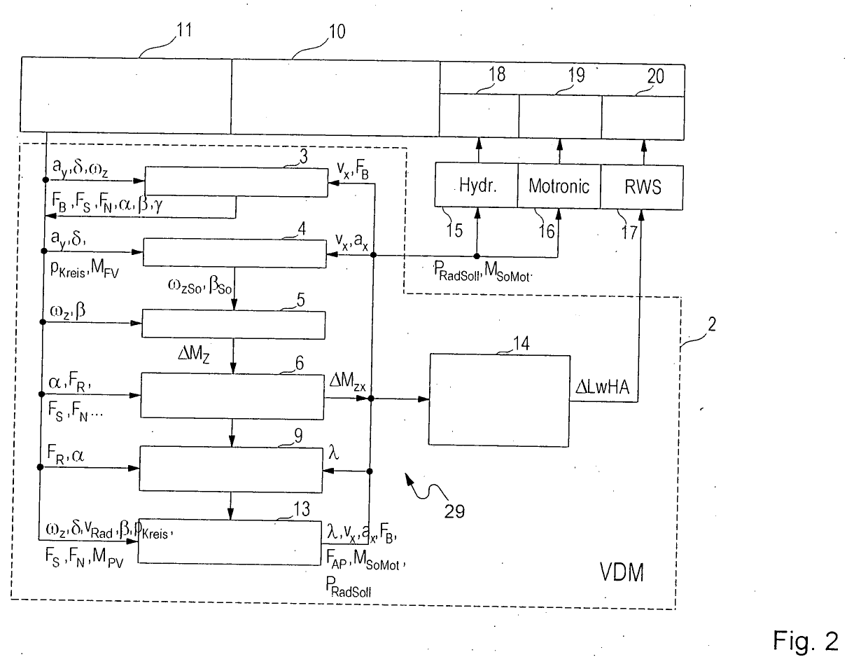

FIG. 2 shows a more precise illustration of different regulator components of the expanded vehicle dynamics controller.

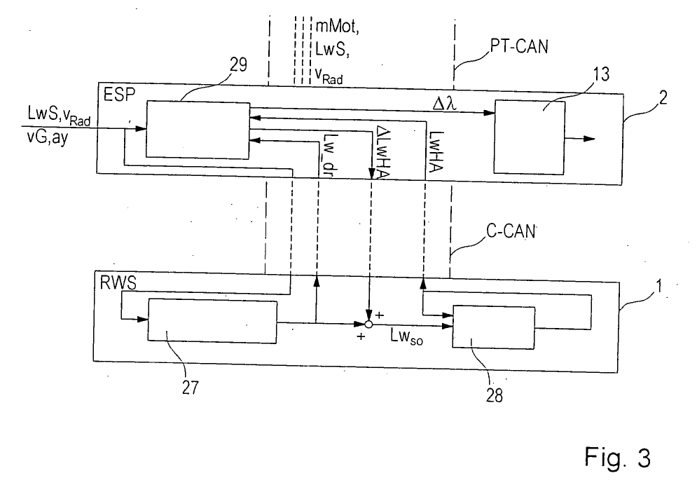

FIG. 3 shows the signal flow between the control unit of the expanded vehicle dynamics control system VDM and the control unit of the rear-wheel steering system RWS.

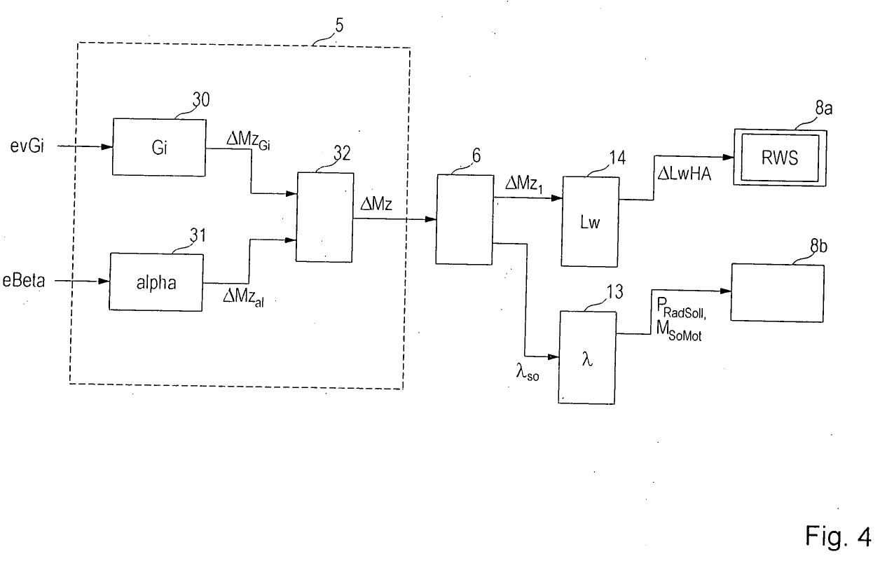

FIG. 4 shows a yaw rate regulator and a float angle regulator of the electronic stability program.

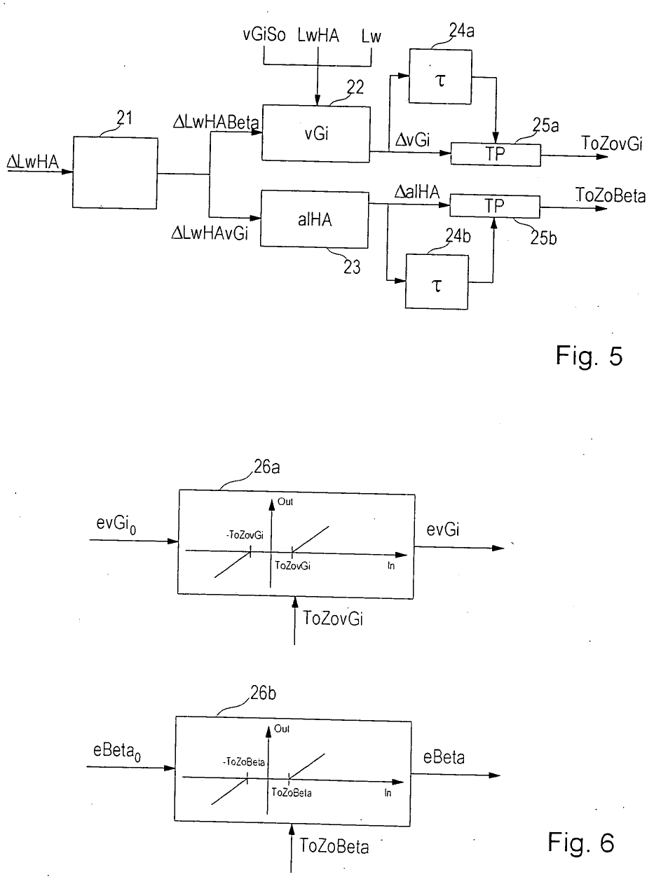

FIG. 5 shows a block diagram for calculating dead zones for the yaw rate and float angle regulation.

FIG. 6 shows the correction of the system deviations as a function of the dead zone.

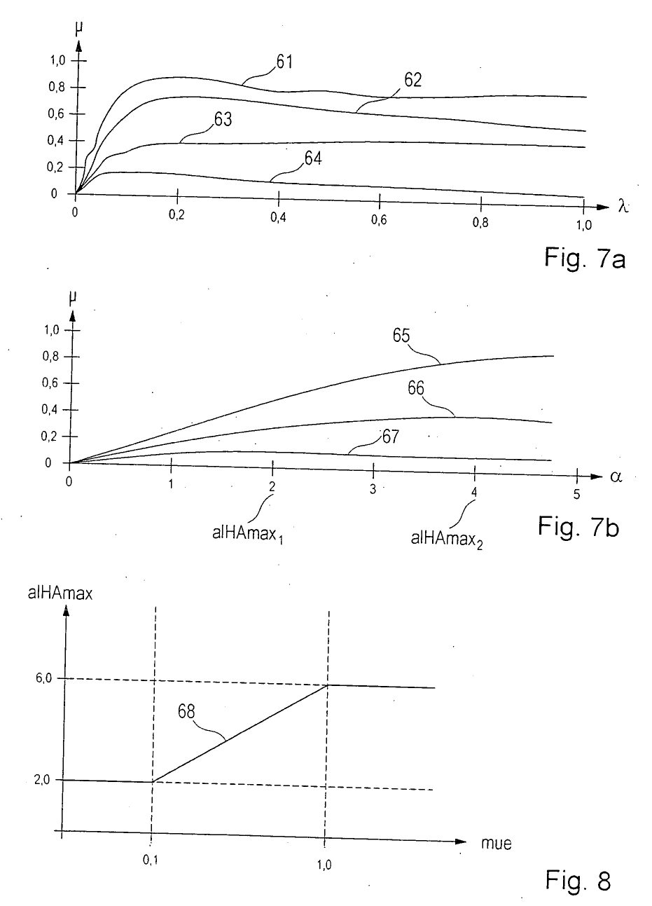

FIGS. 7a, 7b shows the tire identifiers of a tire in the longitudinal and transverse directions of the tire for different road surfaces.

FIG. 8 shows a characteristics map of the slip angle at maximum adhesion for different road surface coefficients of friction.

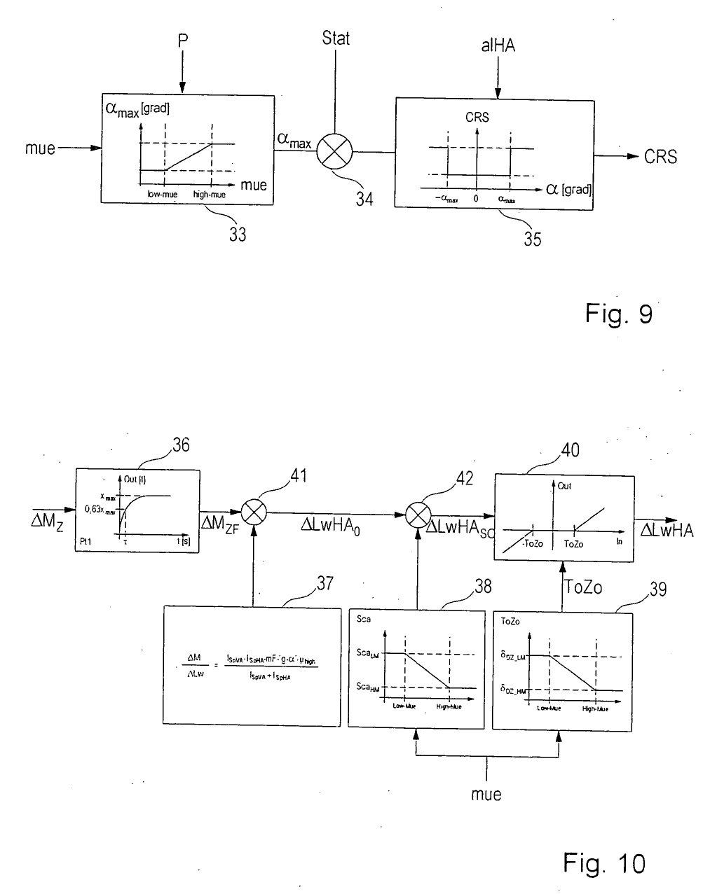

FIG. 9 shows the generation of a clearing signal for braking interventions.

FIG. 10 shows the calculation of the superimposed steering angle for the rear-wheel steering.

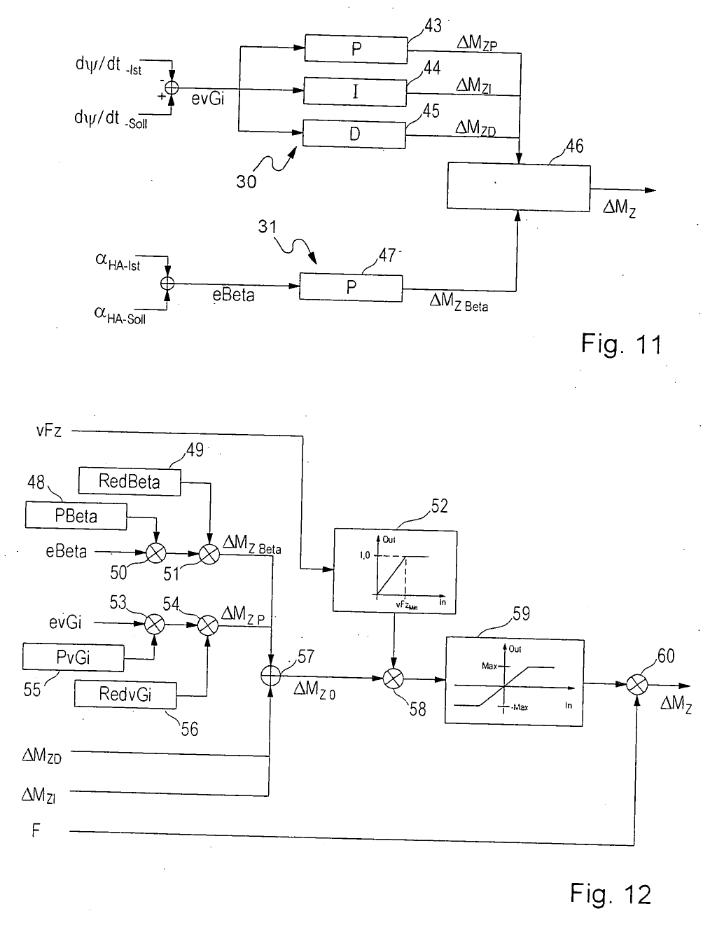

FIG. 11 shows the coarse structure of the electronic stability program.

FIG. 12 shows a more precise illustration of the electronic stability program of FIG. 11.

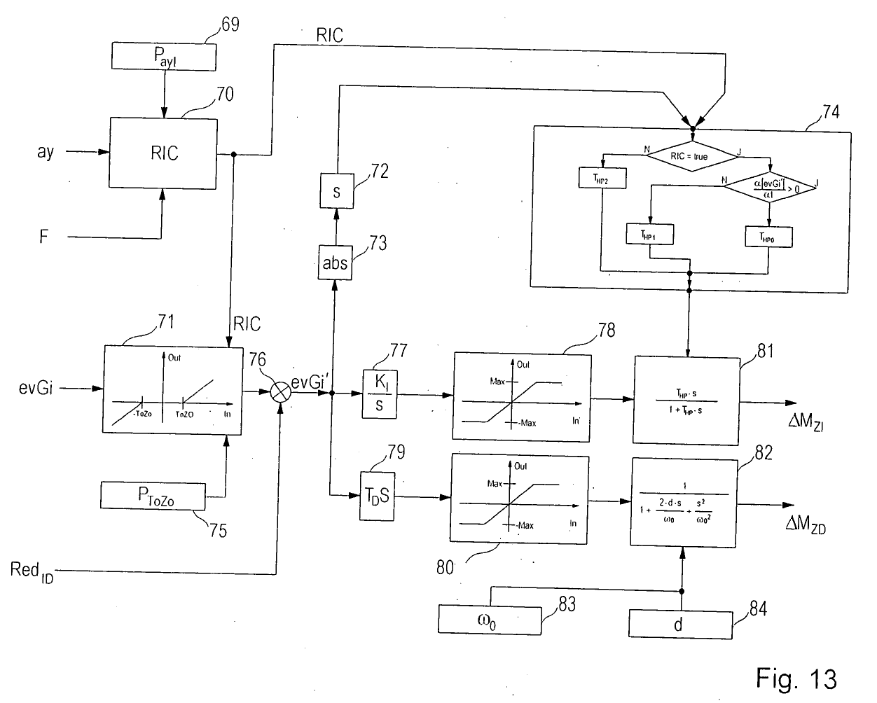

FIG. 13 shows the structure of an I and D regulator of the yaw rate regulator.

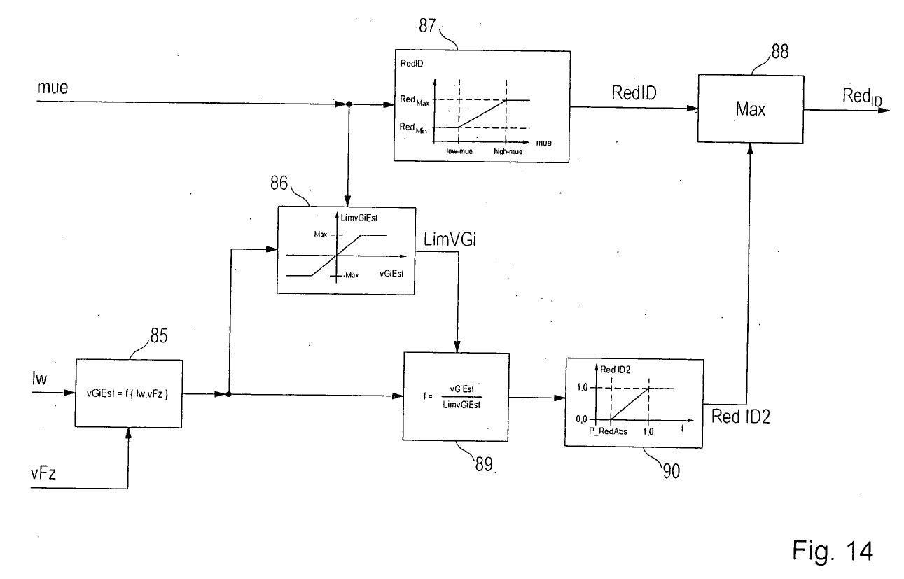

FIG. 14 shows the calculation of a reduction factor for the amplification of the I and D component of the yaw rate regulator as a function of the coefficient of friction.

### DETAILED DESCRIPTION

FIG. 1 shows the regulator structure of an expanded vehicle dynamics control system VDM, which, for stability purposes, is capable of activating a steering control element of an active rear-wheel steering system 8a (RWS) in addition to the brake system and the engine controller (combined in block 8b). The VDM system includes a control algorithm which is shown schematically by blocks 3-6. In this case, reference numeral 3 identifies an “observer,” reference numeral 4 identifies a unit for setpoint value calculation, in which a setpoint yaw rate is determined in particular, and reference numeral 5 identifies a state regulator, whose regulator output variable ΔM_{z} is a yaw moment or a proportional variable.

Furthermore, the control algorithm includes a distributor unit 6, which converts regulator output variable ΔM_{z} into the components ΔLwHA, p_{WheelSet} for individual subsystems 8a (rear-wheel steering system) and 8b (hydraulic unit and motronics), ΔLwHA being a superimposed steering angle (in the form of a steering angle change) for the rear-wheel steering and p_{WheelSet} being a brake pressure for hydraulic system 15, 18.

Individual actuating requests ΔLwHA, p_{WheelSet} are transmitted via interfaces 7a, 7b to control unit 1 of rear-wheel steering system 8a and electronic system 15 (FIG. 2) of active brake system 8b. Circuits 1, 15 then activate final control element 18, 20 (FIG. 2) accordingly, reference numeral 18 identifying a disk brake and reference numeral 20 identifying the steering control element. The new, altered actual status of vehicle 10 is recorded using sensor system 11 and supplied to control algorithm 3-6.

FIG. 2 shows a more detailed view of expanded vehicle dynamics control system VDM from FIG. 1. The entire system includes vehicle 10 as the controlled system, sensors 11 for determining the regulator input variables, final control elements 18-20 for influencing the drivability, and a hierarchically structured regulator 29 (having components 3-6, 9, 13), including a higher-order vehicle dynamics controller 5 (state regulator) and a lower-order braking and drive slip regulator 13. The regulator functions are implemented in control unit 2 of vehicle dynamics control system VDM.

The structure and function of such a vehicle dynamics controller are sufficiently known from the related art (e.g., Bosch, Kraftfahrtechnisches Handbuch [Automotive Handbook], 23rd edition), so that in the following only the functions and, in particular, the differences from known regulators will be discussed: the actual values of the regulated status variables (yaw rate, float angle) are determined in “observer” 3. The setpoint values of the status variables are calculated in unit 4 for setpoint value calculation.

Higher-order state regulator 5 executes a yaw rate and float angle regulation in a known way and generates a regulator output variable ΔM_{z} in the form of a yaw moment or a variable proportional thereto. A part of regulator output variable ΔM_{z} is converted into a setpoint slip lambda_{So}, which is supplied to lower-order braking and drive slip regulator 13. Setpoint slip lambda_{So} calculated for the individual wheels is converted into corresponding manipulated variables p_{WheelSet}, M_{SoEng} for brake system 15, 18 and engine controller 16, 19, which set the required braking and/or driving forces at the individual wheels.

Furthermore, distributor unit 6 generates a partial center of gravity moment ΔM_{zx}, which is to be implemented by rear-wheel steering 17, 20. This center of gravity moment ΔM_{zx} is then converted by a computer unit 14 into a superimposed steering angle ΔLwHA. Superimposed steering angle ΔLwHA is finally added at steering control element 20 to the current rear-wheel steering angle.

The weighting of individual control components p_{WheelSet}, M_{SoEng}, ΔM_{zx} calculated from regulator output variable ΔM_{z} of state regulator 5 may basically be selected arbitrarily, depending on how strong the desired intervention of individual subsystems 8a, 8b is. Preferably, their distribution is a function of the coefficient of friction or the slip angle of the rear wheels, however.

FIG. 3 shows the signal flow between control unit 2 of vehicle dynamics control system VDM and control unit 1 of rear-wheel steering system RWS. To calculate a setpoint yaw moment, vehicle dynamics controller 29 needs rear-wheel steering angle Lw_dr desired by the driver, which is generated by a steering function 27. In addition, vehicle dynamics controller 29 needs actual rear-wheel steering angle LwHA in order to be able to calculate the slip angle of the rear wheels. Actual rear-wheel steering angle LwHA is typically measured.

If necessary, further signals (not shown), such as an “operating status” signal or a “status” signal may also be transmitted between control units 1 and 2 for the security software of vehicle dynamics controller 29 and a clearing software, using which vehicle dynamics controller 29 may be activated and/or deactivated.

RWS control unit 1 includes a control function 27, which calculates rear-wheel steering angle Lw_dr desired by the driver as a function of set steering wheel angle LwS and wheel velocity v_{Wheel}. As long as vehicle 10 is in a stable state, this steering angle Lw_dr is set by a steering angle regulator 28 at the rear axle. In contrast, if vehicle 10 is in an unstable situation, vehicle dynamics controller 29 generates a superimposed steering angle ΔLwHA in the form of a steering angle change which is transmitted to RWS control unit 1, where it is linked to rear-wheel steering angle Lw_dr desired by the driver. Rear-wheel steering angle Lw_{So} resulting therefrom then forms the new setpoint value for steering angle regulator 28.

Cited steering angle information Lw_dr, LwHA, ΔLwHA is transmitted via a data bus, which is also referred to as a chassis CAN. VDM control unit 2 is additionally connected to a second data bus PT CAN, via which different sensor signals of ESP sensor system 11 are input in particular. The separate bus connection between both control units 1, 2 allows particularly rapid and reliable transmission.

FIG. 4 shows a more precise illustration of vehicle dynamics controller 29. This includes a yaw rate regulator 30 and a float angle regulator 31. Float angle regulator 31 is designed for technical reasons as a regulator which limits slip angle alpha of the wheels on the rear axle. Limiting the slip angle on the rear axle has the same effect in vehicle dynamics as regulating the vehicle float angle (beta) or regulating the vehicle lateral velocity, so that the name “float angle regulator” is used here.

The two regulators 30 and 31 receive associated system deviation evGi (yaw rate) and eBeta (slip angle) and they generate a corresponding center of gravity moment ΔM_{zGi} or ΔM_{zBeta}, respectively. Regulator output variables ΔM_{zGi} and ΔM_{zBeta} are processed in block 32, and a center of gravity moment ΔM_{z} is generated therefrom, which is typically a setpoint yaw moment ΔM_{GiSo}.

Finally, distributor unit 6 distributes center of gravity moment ΔM_{z} to the individual subsystems, specifically the brake system and the engine controller (combined in block 8b) and rear-wheel steering system 8a, actuation requests being output in the form of a center of gravity moment ΔM_{z1} and a setpoint slip lambda_{So}. Variables ΔM_{z1}, lambda_{So} are then converted into corresponding manipulated variables ΔLwHA, p_{WheelSet}, M_{SoEng} in blocks 13 and 14.

In an expanded electronic stability program (VDM), as was described above, some special control technology characteristics arise, which will be explained in greater detail in the following:

1. Adaptation of the Regulating Behavior of the Yaw Rate and Float Angle Regulators.

In principle, a control intervention of yaw rate regulator 30 in the rear-wheel steering also has an influence simultaneously on float angle and/or slip angle alHA of vehicle 10. In contrast to braking interventions, the intervention in the rear-wheel steering causes an increase in float angle beta and/or slip angle alHA while reducing yaw rate vGi. A regulating intervention in float angle regulator 31 on the rear-axis steering, in contrast, causes an increase in yaw rate vGi while reducing the float angle. The interventions of both regulators 30, 31 thus act in precisely opposite directions. This will become clearer from the following example:

In the event of too high a yaw rate vGi of vehicle 10, the rear wheels are influenced in the same direction as the front wheels in order to reduce yaw rate vGi. However, the float angle and slip angle alHA on the rear axle are thus increased. This means that operating point deviations occur at float angle regulator 31. This may in turn result in float angle regulator 31 intervening in the driving operation and causing a deflection of the rear wheels in the opposite direction to reduce slip angle alHA. Regulators 30, 31 may thus mutually amplify one another and endanger the driving safety.

To coordinate both regulators 30, 31, it is suggested that the regulating behavior of yaw rate regulator 30 be set as a function of the share of slip angle regulator 31 and control request ΔLwHA for the rear-wheel steering and the regulating behavior of slip angle regulator 31 be set as a function of the share of yaw rate regulator 30. A possibility for coordinating both regulators 30, 31 is illustrated in FIGS. 5 and 6.

FIGS. 5 and 6 show a method in which system deviations evGi and eBeta of yaw rate regulator 30 and float angle regulator 31 are modified as a function of the level of the control intervention of the other regulator 31 or 30, respectively. The sensitivity of regulators 30, 31 is thus influenced. (The regulator sensitivity may alternately also be adapted by changing the control thresholds at the operating point deviations.)

FIG. 5 shows the calculation of dead zones ToZoGi and ToZoBeta, which are used for correcting the operating point deviations of yaw rate regulator 30 and slip angle regulator 31, respectively. The actual correction functions are shown in FIG. 6.

Two correction units 26a and 26b are provided for correcting system deviations evGi and eBeta, respectively; the correction units calculate a corrected system deviation evGi, eBeta from actual system deviations evGi₀, eBeta₀, which are then supplied to regulators 30, 31. Correction units 26a, 26b define a dead zone ToZo, i.e., a range of the system deviation in which system deviation evGi, eBeta is set to zero, and a range in which the actual system deviation is reduced by a predefined absolute value. If actual system deviation evGi₀ or eBeta₀ is located within the dead zone, whose boundaries are predefined by the values ±ToZoGi and ±ToZoBeta, corrected system deviations evGi and eBeta supplied to regulators 30, 31 are set to zero. Outside the dead zone, actual system deviations evGi₀ and eBeta₀ are reduced by value ToZoGi and ToZoBeta, respectively. Operating point deviations of yaw rate regulator 30 and float angle regulator 31 may thus be compensated for.

The calculation of dead zones ToZoGi and ToZoBeta is schematically illustrated in FIG. 5. The calculation includes a block 21, in which components ΔLwHABeta, ΔLwHAvGi of both regulators 30, 31 of superimposed steering angle ΔLwHA are calculated. In this case, ΔLwHABeta is the share of float angle regulator 31 and ΔLwHAvGi is the share of yaw rate regulator 30 in overall superimposed steering angle ΔLwHA.

The change of yaw rate ΔvGI and the change of float angle and/or slip angle ΔalHA are calculated in blocks 22 and 23. Because of an intervention of float angle regulator 31 yaw rate deviation ΔvGI results in this case from:
ΔvGI=−ΔLwHABeta*vGi_{So}/(Lw−LwHA) (1)
and because of an intervention of yaw rate regulator 30 slip angle deviation ΔalHA results in:
ΔalHA=−ΔLwHAvGi (2)

In this case, Lw is the front-wheel steering angle, LwHA is the rear-wheel steering angle, and vGi_{So} is the yaw rate without the adjustment of float angle regulator 31.

Actuators 20 of the active rear-wheel steering typically operate very rapidly; however, the operating point deviations are not established immediately. The inertia of the actuator system and the entire vehicle may be simulated by a suitably adapted low-pass filtering 24, 25. Operating point deviations ΔvGI and ΔalHA are therefore each supplied to a low-pass filter 25a, 25b, at whose output values ToZovGi and ToZoBeta for the above-mentioned dead zones are output. Filter time constant tau is set as a variable here as a function of the curve of operating point deviations ΔvGI, ΔalHA using units 24a and 24b. In this case, different time constants tau are selected in particular for signals ΔvGI and ΔalHA, which become larger and smaller.

The operating point deviations from equations (1) and (2) may, for example, be added directly to the corresponding setpoint values. Preferably, however, the absolute value of each of operating point deviations ΔvGI and ΔalHA is determined and the value for a dead zone ToZovGi and ToZoBeta, respectively, is calculated therefrom. In this case:
ΔvGI=|LwHABeta*vGiso/(Lw−LwHA)|=ToZovGi (3)
and
ΔalHA=|ΔLwHAvGi|=ToZoBeta (4)

In this case, vGi_{So} is the setpoint yaw rate, Lw is the front axle steering angle, and LwHA is the rear axle steering angle.

Equations (1)-(4) may be derived from the known linear single track model. Accordingly, the following equation applies for setpoint yaw rate vGi_{So}:
υGi_{So}=((Lw−LwHA)*v)/(1*(1+(υ/υ_{ch})²)) (5)
with υ being vehicle velocity, 1 being wheelbase, and υ_{ch} being characteristic velocity.

Through differentiation, the following equation results from equation (5):
ΔυGi_{So}=(−ΔLwHA*v)/(1*(1+(υ/υ_{ch})²)) (6)
with
υGi being yaw rate change and ΔLwHA being change of the rear-wheel steering angle.

After rearranging and equating the equations (5) and (6), the change of yaw rate ΔvGi_{So} as a function of a steering angle change at the rear axle results:
ΔvGi_{So}=−ΔLwHA*vGi_{So}/(Lw−LwHA) (7)

The equations of the linear single track model also provide a statement about the slip angle at the rear axle, in which the following applies:
alHA=−LwHA+Beta−vGi_{Actual}*1HA/v (8)
where
Beta is the float angle of the vehicle center of gravity
vGi_{Actual} is the measured yaw rate and
1HA is the distance of the rear axle relative to the center of gravity.

After differentiation, the following equation results for the slip angle change, i.e., float angle change ΔalHA as a result of a steering angle change ΔLwHA at the rear axle:
ΔalHA=−ΔLwHA (9)
2. Activation/Deactivation of the Yaw Rate Regulator in Specific Ranges as a Function of the Slip Angle

FIGS. 7-9 show the generation of a clearing signal CRS, using which a control intervention of brake hydraulics 15, 18 may be permitted or suppressed. Clearing signal CRS is generated in such a way that in the range of higher slip angles alHA, stabilization interventions are permitted both using the active rear-wheel steering and also using engine controller 16, 19 or brake system 15, 18. In contrast, in the range of smaller slip angles alHA, stabilization interventions by brake system 15, 18 and/or engine controller 16, 19 are suppressed, and only rear-wheel steering system 17, 20 is used for vehicle stabilization. Alternately, ESP stability interventions in this range may also only be strongly reduced.

FIG. 7a shows the tire identifier (μ/slip characteristic curve) in the longitudinal direction of the tire for different road surfaces. In this case, reference numeral 61 identifies the coefficient of friction curve for a dry road surface, reference numeral 62 for a wet road surface, reference numeral 63 for snow, and reference numeral 64 for ice.

FIG. 7b shows the tire identifier (μ/slip angle characteristic curve) in the transverse direction of the tire for different road surfaces. In this case, reference numeral 65 identifies a dry road surface, reference numeral 66 identifies snow, and reference numeral 67 identifies ice.

Characteristic curves 65-67 are continuous, having a positive gradient starting from the origin until a maximum coefficient of friction is reached and then are essentially flat or have a negative gradient. Those slip angles alpha at which the tires have a maximum adhesion in the transverse direction are referred to in this case as alHAmax.

For stability regulation using rear-wheel steering, this characteristic curve means that at small slip angles (alpha<alHAmax) the lateral forces may be expediently modulated, while at large slip angles (alpha>alHAmax) hardly any change or no change of the tire transverse forces may be achieved through a steering angle change ΔLwHA, since the gradient of characteristic curves 65-67 is nearly zero in this range. In the range of larger slip angles, it is therefore necessary to permit stronger ESP stability interventions in brake system 15, 18 and in engine controller 16, 19. The steering intervention in rear-wheel steering 17, 20 is expressly not suppressed in this case, since an interruption of the active rear-wheel steering would result in an altered drivability of the vehicle and would irritate the driver.

The individual steps of the calculation of clearing signal CRS are illustrated in FIGS. 8 and 9. In this case, FIG. 8 shows a characteristic curve 68, which approximates the curve of slip angle alHAmax having maximum adhesion at different road surface coefficients of friction μ.

FIG. 9 shows the actual functions for generating clearing signal CRS. In this case, block 33 determines slip angle alHAmax having maximum adhesion at a predefined coefficient of friction μ according to the characteristic curve of FIG. 8. Coefficient of friction μ is typically an estimated variable of vehicle dynamics controller 29, which is determined from the center of gravity accelerations of the vehicle in the longitudinal and transverse directions.

With operational rear-wheel steering, whose status signal Stat is taken into account at node 34, function block 35 generates clearing signal CRS through simple threshold value comparison. If current slip angle alHA is greater than threshold value alHAmax, signal CRS is set to “true” and therefore ESP interventions are permitted. Otherwise, signal CRS is set to “false” and ESP interventions are thus suppressed. Signal CRS is a Boolean signal.

3. Calculating the Superimposed Steering Angle from the Regulator Output Variable

FIG. 10 shows the calculation of superimposed steering angle ΔLwHA from regulator output variable ΔM_{z} of state regulator 5. The algorithm shown is particularly robust for regulation. In addition, activation signals ΔLwHA for the rear-wheel steering system which are understood as plausible by the driver are generated.

The algorithm includes a low-pass filter 36, which is implemented here as a Pt1 filter and generates a filtered moment signal ΔM_{zF}. The low-pass filtering of the center of gravity moment change ΔM_{z} is shown using a constant filter time constant, but may also be optionally implemented as a function of the coefficient of friction. Signal ΔM_{zF} is converted into a raw value ΔLwHA₀ for steering angle change ΔLwHA using function 37. Raw value ΔLwHA₀ of the superimposed steering angle is then scaled as a function of the coefficient of friction using a function 38, smaller values ΔLwHA_{Sc} basically being generated in the event of larger coefficients of friction μ at node 42. Scaling 38 allows adaptation specific to the customer and vehicle in particular.

Scaled superimposed steering angle ΔLwHA_{Sc} is finally reduced using a function 40, which in turn defines a dead zone ToZo, in which superimposed steering angle ΔLwHA is set to zero. The size of dead zone ToZo is a function of the coefficient of friction, it basically being smaller at larger coefficients of friction than at smaller coefficients of friction. The functional relationship between the size of dead zone ToZo and coefficient of friction μ is predefined by a function 39. Dead zone ToZo causes robustness of the regulation against signal noise and parameter oscillations in particular.

4. Special Embodiment of the Yaw Rate Regulator

FIGS. 11 through 14 show an embodiment of vehicle dynamics controller 29, in which yaw rate regulator 30 is implemented as a PID regulator. The quality of the stabilization may thus be improved in comparison to a simple P regulator.

FIG. 11 shows the coarse structure of state regulator 5, yaw rate regulator 30 having a P component 43, an I component 44, and a D component 45. Regulator components 43-45 each generate their own output variable in the form of a moment ΔM_{zP}, ΔM_{zI}, ΔM_{zD} relative to the center of gravity from system deviation evGi between actual and setpoint yaw rates dPsi/dt.

Float angle regulator 31 is implemented as P regulator 47 and generates a moment change ΔM_{zBeta} from system deviation eBeta between actual and setpoint slip angles alHA. The regulator components of regulator 30 and 31 are processed in block 46 and a resulting moment ΔM_{z} relative to the center of gravity is calculated. This moment ΔM_{z} is then in turn distributed to the individual subsystems.

FIG. 12 shows a possible embodiment of a yaw rate regulator 30, in which system deviations evGi and eBeta are first multiplied by amplification factors pvGi 55 and pBeta 48, respectively, of purely proportional regulator components 43, 47 (nodes 50, 53). The amplified system deviation is then multiplied by reduction factors RedBeta 49 and RedvGi 56, respectively, in favor of the regulator components of I and D regulators 44, 45. Instead of multiplication by factors pBeta, pvGi and the subsequent reduction by reduction factors 49, 46, multiplication by one single amplification factor may also be performed. However, the implementation shown allows a standard layout of PID regulator 30 and an application-specific reduction on the basis of reduction factors 49 and 56.

P components ΔM_{zP}, eBeta, D component ΔM_{zD}, and I component ΔM_{zI} are added at node 57. A linkage of components ΔM_{zP}, ΔM_{zD}, and ΔM_{zI} as a function of the driving situation or a calculation of amplification factors 48, 49, 55, 56 as a function of the driving situation may also be provided, for example. In this case, the cited variables may be linked as a function of the coefficient of friction, the vehicle velocity, or other status variables, for example.

The addition at node 57 results in a raw value ΔM_{z0}, which is limited at node 58 as a function of vehicle velocity vFz. In this way, in particular at low vehicle velocities, manipulated variable ΔM_{z} may be reduced and therefore smaller control interventions may occur. A corresponding reduction function is shown in block 52. The resulting signal is also limited by a limiting function 59 for reasons of safety. In this way, it may be ensured that impermissibly large control requests may be suppressed. The overall regulator may also be deactivated and/or cleared at node 60 using a signal F. Finally, variable ΔM_{z} may be provided for the further computing sequence within vehicle dynamics controller 29 and, as described above, manipulated variables ΔLwHA, p_{WheelSet}, and M_{SoEng} may be derived for the different subsystems.

FIGS. 13 and 14 show the generation of I and D components ΔM_{zI}, ΔM_{zD} of regulator output variable ΔM_{z}. I and D components ΔM_{zI}, ΔM_{zD} are a function of the coefficient of friction in particular in this case. Time constant T_{HP} of I regulator 44 is also a function of coefficient of friction μ.

FIG. 13 shows an algorithm 70 on the top left, which, as a function of clearing signal F, lateral acceleration ay, and taking into consideration a parameter P_{ayI}, generates a resulting clearing signal RIC. This signal RIC determines overall whether a regulator component ΔM_{zI} of I regulator 44 and a regulator component ΔM_{zD} of D regulator 45 is generated or not. Signal RIC is then supplied to an algorithm 71 and an algorithm 74.

Algorithm 71 is used to reduce system deviation evGi and may, for example, include a function having a dead zone ToZo. The size of the dead zone is in turn predefined by a parameter P_{ToZo} 75. The resulting value of system deviation evGi is then linked at node 76 to a reduction factor Red_{ID} and a signal evGi′ is generated. Signal RIC also has an influence on the size of dead zone ToZo in algorithm 71. In addition, the size of dead zone ToZo may also be determined as a function of the driving condition or other influencing variables.

Subsequently, undesired signal components are filtered out of signal evGi′ using filters 77 and 79. The resulting signals are then limited to maximum values by functions 78 and 80. This is again performed for reasons of safety.

The actual regulator functions of I regulator 44 and D regulator 45 are illustrated in blocks 81 and 82. The D regulating algorithm is implemented here as a second-order low-pass filter. Regulator parameters natural frequency omega₀ and damping d are supplied by block 83 and 84.

I regulator 81 is implemented here as a first-order high-pass filter. Time constant T_{HP} is variable and is predefined by block 74 as a function of signal evGi′, which is in turn a function of the coefficient of friction. Time constant T_{HP} is essentially determined as follows: a base signal for the selection of high-pass filter time constant T_{HP} is generated from signal evGi′ using absolute value calculation 73 and differentiation 72. The selection algorithm is shown as block 74. It is first queried therein whether the status of the RIC signal is active. If not, a higher value T_{HP2} is selected for time constant T_{HP} of high-pass filter 81. If clearing signal RIC is low and/or inactive, it is checked whether signal evGi′ has a positive or negative gradient. In the case of a positive gradient, very small value T_{HP0} is selected for time constant T_{HP}, and in the case of a negative gradient, a larger value T_{HP1} is selected for time constant T_{HP}, with T_{HP2}>T_{HP1}>T_{HP0}.

Filter functions 77, 79 upstream from I and D regulators may, for example, have constant parameters. Alternately, it is also possible to set one or more of the filter parameters as a function of the driving situation, in particular vehicle velocity vFz, lateral acceleration ay, or another driving condition. Resulting signal components ΔM_{zI} and ΔM_{zD} are then supplied to vehicle dynamics controller 29 for further processing.

FIG. 14 shows the determination of reduction factor Red_{ID}, by which system deviation evGi is multiplied. The function of reduction factor Red_{ID} is to prevent excessively high integral regulator components ΔM_{zI} in particular. The algorithm for calculating reduction factor Red_{ID} essentially has two branches. The upper branch includes a block 87 having a function, using which a reduction factor Red_{ID1} is calculated as a function of estimated coefficient of friction μ. Coefficient of friction μ may be estimated by vehicle dynamics controller 29 from the lateral and longitudinal accelerations of vehicle 10, for example.

Since the coefficient of friction is determined from the vehicle acceleration, the signal value in the event of steady-state straight-line travel is approximately zero. Only in the event of stronger longitudinal or lateral acceleration does coefficient of friction μ assume the actual value near 1. This behavior is rather unfavorable for determining a suitable regulator amplification.

The second branch includes a function 85, using which a setpoint yaw rate vGi_{So} is calculated according to the linear single track model. In this model, vehicle velocity vFz and front axle steering angle lw enter as input variables. The signal of the setpoint yaw rate is then limited in block 86 as a function of the coefficient of friction via complex filtering algorithms and an output signal LimvGi is generated. The input and output signals of filter algorithm 86 are subjected in block 89 to an expanded quotient calculation, which prevents division by zero and keeps the value range from being exceeded. In case of travel on a road surface having a high coefficient of friction, the quotient from block 89 results in values near one. In block 90, these values are weighted to make calibration possible and reduction factor Red_{ID2} is generated. Finally, in block 88, the maximum value is selected from both reduction factors Red_{ID1} and Red_{ID2} and output as a value Red_{ID}.

This method has the advantage in particular that at the beginning of a stability regulation, in particular starting from steady-state straight-line travel, value Red_{ID} is not too low and is stabilized at an exact function of the coefficient of friction in the course of the stability regulation. The extent of the amplification reduction is settable during the calibration of the control algorithms in this case.

### List Of Reference Numerals

1 RWS control unit
2 ESP control unit
3 observer
4 unit for setpoint value calculation
5 state regulator
6 distributor unit
7 interfaces
8 RWS algorithm
9 unit for setpoint slip calculation
10 vehicle
11 sensor system
13 braking and drive slip regulator
14 unit for superimposed steering angle calculation
15 electronics of the brake system
16 motronics
17 RWS electronics
18 disk brake
19 final control elements of the engine controller
20 steering control element
21 determination of the steering angle components
22 calculation of the operating point deviation for the yaw rate
23 calculation of the operating point deviation for the slip angle
24 determination of the filter time constant
25 low-pass filter
26a correction of the system deviation of the yaw rate
26b correction of the system deviation of the float angle
27 rear-wheel steering function
28 rear-wheel steering angle regulator
29 vehicle dynamics controller
30 yaw rate regulator
31 float angle regulator
32 coordination of the regulator components
33 determination of the slip angle at maximum adhesion
34 multiplication node
35 generation of clearing signal CRS
36 Pt1 filter
37 conversion function for the superimposed steering angle
38 scaling function
39 characteristic curve for the dead zone
40 limiting function
41 multiplication node
42 multiplication node
43 P regulator
44 I regulator
45 D regulator
46 coordination of the regulator components
47 P regulator
48 amplification factor of the float angle regulator
49 reduction factor of the float angle regulator
50 multiplication node
51 multiplication node
52 limitation as a function of vehicle velocity
53 multiplication node
54 multiplication node
55 amplification factor of P regulator 43
56 reduction factor of the P regulator
57 addition node
58 multiplication node
59 limiting function
60 multiplication node
61-64 tire identifiers in longitudinal direction
65-67 tire identifiers in transverse direction
68 curve of the slip angle at maximum adhesion
69 parameter
70 generation of clearing signal RIC
71 limiting function
72 differentiation
73 absolute value calculation
74 algorithm for selecting time constant T_{HP}
75 dead zone
76 multiplication node
77 integrator
78 limiting of the I component
79 filter
80 limiting of the D component
81 I regulator function
82 D regulator function
83 natural frequency
84 damping
85 linear single track model
86 filtering
87 determination of a reduction factor
88 selection of the maximum value
89 quotient calculation
90 determination of reduction factor RED_{ID2}
ay lateral acceleration
evGi system deviation of the yaw rate
RED_{ID} reduction factor
evGi′ signal value of the system deviation of the yaw rate
ΔM_{zI} I component
ΔM_{zD} D component
ΔM_{zP} p component
ΔM_{z} regulator output variable
RED_{ID1} reduction factor
RED_{ID2} reduction factor
μ coefficient of friction
Lw front axle steering angle
eBeta system deviation of the float angle
CRS clearing signal
F clearing signal
ToZo dead zone
ΔLwHA superimposed steering angle
ΔLwHA₀ raw value of the superimposed steering angle
ΔLwHA_{Sc} scaled superimposed steering angle
alHA slip angle rear axle
alHAₘₐₓ slip angle at maximum adhesion
P parameter
Stat status signal
ToZoGi dead zone of the yaw rate regulator
ToZoBeta dead zone of the float angle regulator
ΔvGI operating point deviation of the yaw rate regulator
ΔalHA operating point deviation of the float angle regulator
tau time constant
evGi₀ raw value of the system deviation
eBeta₀ raw value of the system deviation
p_{WheelSet} manipulated variable
m_{SoEng} manipulated variable
Lw_dr desired rear-wheel steering angle
LwHA measured rear-wheel steering angle

What is claimed is:

1. A device for stabilizing a vehicle in a critical driving situation, comprising:
a vehicle dynamics control system including:
a control unit,
a vehicle dynamics controller,
at least one final control element, and
a sensor system for measuring different driving condition variables; and
a rear-wheel steering system having control electronics and a final control element, wherein:
the vehicle dynamics controller includes a distributor unit that, from a regulator output variable, generates both a manipulated variable for the at least one final control element of the vehicle dynamics control system and a manipulated variable for the at least one final control element of the rear-wheel steering system.

2. The device as recited in claim 1, wherein the regulator output variable of a state regulator is one of a yaw moment and a variable proportional thereto.

3. The device as recited in claim 1, wherein:
the control unit of the vehicle dynamics control system and the control unit of the rear-wheel steering system are connected to a bus, via which steering angle information is transmitted, the control unit of the vehicle dynamics control system being connected to a second bus.

4. The device as recited in claim 1, wherein:
the vehicle dynamics controller includes a yaw rate regulator and a slip angle regulator, each of which generates an output variable, from which a manipulated variable for the final control element of the rear-wheel steering system is derived, the regulating behavior of the yaw rate regulator being set as a function of the share of the slip angle regulator in the manipulated variable for the rear-wheel steering system, and the regulating behavior for the slip angle regulator being set as a function of the share of the yaw rate regulator in the manipulated variable for the rear-wheel steering system.

5. The device as recited in claim 4, wherein:
the system deviation of the yaw rate regulator is set as a function of the share of the slip angle regulator in the manipulated variable for the rear-wheel steering system, and
the system deviation of the slip angle regulator is set as a function of the share of the yaw rate regulator in the manipulated variable for the rear-wheel steering system.

6. The device as recited in claim 4, wherein:
the control threshold of the yaw rate regulator is set as a function of the share of the slip angle regulator in the manipulated variable for the rear-wheel steering system, and
the system deviation of the slip angle regulator is set as a function of the share of the yaw rate regulator in the manipulated variable for the rear-wheel steering system.

7. The device as recited in claim 5, further comprising:
a unit for correcting the system deviation of the yaw rate regulator and a unit for correcting the system deviation of the slip angle regulator as a function of one of the share of the yaw rate regulator and the slip angle regulator, respectively, in the manipulated variable for the rear-angle steering system.

8. The device as recited in claim 7, wherein the correction units define a dead zone, in which the particular system deviation is set to a predefined value, in particular zero.

9. The device as recited in claim 1, wherein the vehicle dynamics controller includes a yaw rate regulator and a slip angle regulator, as well as a unit that, as a function of a slip angle, generates a clearing signal that one of activates and deactivates the yaw rate regulator.

10. The device as recited in claim 1, wherein the vehicle dynamics controller includes a device for determining a slip angle at maximum adhesion for a predefined road surface.

11. The device as recited in claim 1, further comprising:
a unit for converting the regulator output variable into a superimposed steering angle for the rear-wheel steering system.

12. The device as recited in claim 11, wherein the superimposed steering angle is scaled as a function of the coefficient of friction of the road surface.

13. The device as recited in claim 10, further comprising:
a unit that defines a dead zone, in which the superimposed steering angle is set to a predefined value.

14. The device as recited in claim 9, wherein the yaw rate regulator includes a PID regulator.

15. The device as recited in claim 14, wherein the regulating behavior of the yaw rate regulator is set as a function of the coefficient of friction of the road surface.

16. The device as recited in claim 14, wherein the system deviation of the yaw rate regulator is varied as a function of the coefficient of friction of the road surface.

17. A method for stabilizing a vehicle in critical driving situations, which, in addition to a vehicle dynamics control system having a control unit, a final control element, and a sensor system, an additional rear-wheel steering system having its own control unit and a final control element, the vehicle dynamics controller executing a yaw rate regulation and a float angle regulation and generating a regulator output variable, wherein both a manipulated variable for the final control element of the vehicle dynamics control system and a manipulated variable for the final control element of the rear-wheel steering system are derived from the regulator output variable.

18. The method as recited in claim 17, wherein the vehicle dynamics controller includes a yaw rate regulator and a slip angle regulator, each of which generates a manipulated variable, from which a manipulated variable for the final control element of the rear-wheel steering system is derived, the regulating behavior of the yaw rate regulator being set as a function of the share of the slip angle regulator in the manipulated variable for the rear-wheel steering system, and the regulating behavior of the slip angle regulator being set as a function of the share of the yaw rate regulator in the manipulated variable for the rear-wheel steering system.

19. The method as recited in claim 18, wherein the system deviation of the yaw rate regulator is set as a function of the share of the slip angle regulator in the manipulated variable for the rear-wheel steering system, and the system deviation of the slip angle regulator is set as a function of the share of the yaw rate regulator in the manipulated variable for the rear-wheel steering system.

20. The method as recited in claim 17, wherein a clearing signal is generated using a unit which activates or deactivates the yaw rate regulator as a function of a predefined slip angle.

21. The method as recited in claim 17, wherein the regulating behavior of the yaw rate regulator is changed as a function of an estimated coefficient of friction.

22. The method as recited in claim 17, wherein the system deviation is reduced as a function of the coefficient of friction.

23. The method as recited in claim 17, wherein at least one of the manipulated variable of the integral component and the manipulated variable of the D component of the yaw rate regulator is a function of the estimated coefficient of friction.

24. The device as recited in claim 8, wherein the predefined value is zero.

25. The device as recited in claim 13, wherein the predefined value is zero.
